(19) United States
(12) Patent Application Publication
(10) Pub. No.: US 2026/0338024 A1
(43) Pub. Date: Oct. 29, 2026

(54) POWERED WINDOW WITH ANTI-IMPINGEMENT AND SMOOTH VELOCITY

(71) Applicant: FORD GLOBAL TECHNOLOGIES, LLC, DEARBORN, MI (US)

(72) Inventor: David S. Cameron, Grosse Pointe Farms, MI (US)

(21) Appl. No.: 19/188,597

(22) Filed: Apr. 24, 2025

(51) Int. Cl. E05F 15/695; E05F 15/41; E05F 15/697; H02P 3/08; H02P 7/00; H02P 7/03

(52) U.S. Cl. CPC E05F 15/695; E05F 15/41; E05F 15/697; H02P 3/08; H02P 7/0094; H02P 7/04; E05Y 2400/336; E05Y 2400/36; E05Y 2400/40; E05Y 2400/554; E05Y 2400/854; E05Y 2800/40; E05Y 2900/55

(57) ABSTRACT

A window is moved within a window opening of a vehicle. A DC motor has a rotor mechanically coupled to the window. A variable voltage source is coupled to the DC motor to supply a selected voltage to rotate the rotor at a respective speed. A ripple detector generates first rotation pulses of the rotor in response to a back electromotive force (EMF) at a first resolution. A Hall-Effect rotation sensor senses rotation of the rotor according to second rotation pulses at a second resolution which is lower than the first resolution. A control circuit is configured to move the window to comply with a predetermined trajectory (e.g., speed of movement and stopping positions) by adjusting the variable voltage source based on (1) a position determined by counting the second rotation pulses and (2) a speed determined by a timing of the first rotation pulses.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to electric powered windows in automobiles, and, more specifically, to controlling a brushed DC motor for driving window movement based on lower resolution rotation-sensor data and higher resolution back-EM F ripple data.

Automotive vehicles are commonly equipped with powered windows that move up and down within a vehicle door opening. Some vehicles have a sunroof or moon roof that moves a closure member fore and aft between closed and open positions within a roof of the vehicle. The powered window and moon roof assemblies typically include a glass window that is powered by an electric motor to slide within a set of guides between an open position and a closed position (e.g., to either cover or unblock an opening in the body of the vehicle). When the window moves to the closed position, it is desirable to prevent impingement of an object.

In order to minimize the risk of impingement, vehicles may be equipped with an anti-impingement control. For example, the electric current of the motor may reveal an increased load indicative of impingement. When the sensed current reaches a threshold value, the motor may be controlled to stop and/or reverse direction. An anti-impingement function is useful when the window controls have a feature which allows the window to close with a single window-control action. Federal Motor Vehicle Safety Standard (FMVSS) No. 118 covering Power-Operated Window, Partition, and Roof Panel Systems states that if a window (as it is closing) meets an object such that the force applied to the object exceeds 100N while in a predetermined range of “Bounceback” operation (wherein the window is located between 4 mm and 200 mm from being closed), then the window should reverse direction.

One preferred type of DC motor is a brushed motor. The speed of the motor and the output torque or force can be controlled by varying the DC voltage that is supplied to the motor. Most commonly, the DC motor is coupled to a fixed DC source through switching devices (e.g., field-effect transistors) connected in an H-bridge configuration so that polarity of the voltage to the motor can be reversed according to whether the window is to be opened or closed. A predetermined trajectory of window movement may be defined which specifies a desired travel speed together with stopping locations coinciding with the fully closed and opened positions.

To obtain a variable DC voltage, the H-bridge switching devices may be pulse-width modulated with the frequency and duty cycle of the switching being controlled to obtain the desired trajectory. A PWM controller preferably operates using closed-loop feedback of the window position to ensure that the trajectory is followed. In order to feedback the changing location of the window along the trajectory, the rotation of the rotor within the DC motor is typically monitored. Some power window drives have utilized Hall-effect sensors sensitive to movement of one or more magnets rotating with the motor shaft. To avoid inefficiencies associated with Hall-effect sensors, other systems have operated without position sensors by instead obtaining position information from back electromotive force (EMF) signals inherently generated during motor operation. The position information is derived from ripple signals induced in the current flowing through the motor. In either case, pulses (from the Hall-effect sensors or in the ripple signals) are counted as the window moves from a known position to update the current position of the window. Window speed can be determined according to the number of pulses received during a particular period of time.

Hall-effect sensors have relatively low resolution of the position measurements when used with small DC motors which may cause the window to shudder while moving. A smooth, steady motion is desired for providing a feeling of quality.

Tracking a ripple signal for position monitoring is able to provide a higher position resolution (typically 11 pulses per one rotor rotation), which results in obtaining faster and more constant motor speeds. However, ripple counting may be subject to lost pulses.

### SUMMARY OF THE INVENTION

In one aspect of the invention, an apparatus is provided for moving a slidable panel in an opening of a vehicle. A DC motor has a rotor adapted to be mechanically coupled to the slidable panel. A variable voltage source is coupled to the DC motor to supply a selected voltage to rotate the rotor at a respective speed. A ripple detector detects rotation of the rotor in response to a back electromotive force (EMF) according to first rotation pulses at a first resolution. A Hall-Effect rotation sensor is coupled to the rotor for sensing rotation of the rotor according to second rotation pulses at a second resolution, wherein the second resolution is lower than the first resolution. A control circuit is configured to move the slidable panel to comply with a predetermined trajectory by adjusting the variable voltage source based on (1) a position determined by counting the second rotation pulses and (2) a speed determined by a timing of the first rotation pulses.

### BRIEF DESCRIPTION OF THE DRAWINGS

FIG. 1 is a schematic diagram showing a powered trajectory of a window of a vehicle.

FIG. 2 is a block diagram showing a window system of a kind used in the present invention.

FIG. 3 is a signal plot showing conversion of a motor current signal into pulses for ripple counting.

FIG. 4 is a logic diagram showing a counting of position pulses and detection of a bounceback region.

FIG. 5 is a signal plot comparing resolution of position pulses derived from a Hall-effect sensor and from ripple counting.

FIG. 6 is a speed plot comparing deviations from a desired speed based on lower and higher position resolution.

FIG. 7 is a block diagram showing a DC motor and H-bridge used in one embodiment of the invention.

FIG. 8 is a block diagram showing derivations of position and speed in a motor controller using Hall-effect sensing.

FIG. 9 is a block diagram showing an embodiment of the invention using Hall-effect sensing for determining position and using ripple sensing for determining motor speed.

FIG. 10 is a graph showing window height for a bounceback region and impacts on the force limits obtained for closing and sealing a window.

### DETAILED DESCRIPTION OF PREFERRED EMBODIMENTS

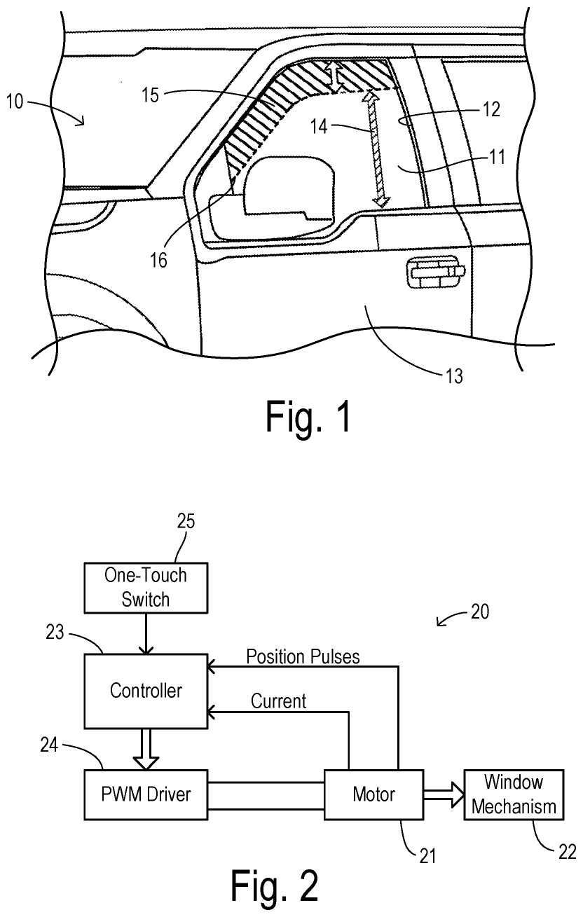

Referring to FIG. 1, a vehicle 10 has an electric motor-driven window 11 in a window opening 12 of a vehicle door 13. Window 11 moves along an up-and-down trajectory 14 between a closed position, an open position, and intermediate positions. For purposes of an anti-impingement feature when using of an automatic window closing function, a bounceback region 15 is defined as a range of window positions where reduced window force should be applied. When window 11 is automatically closing and enters bounceback region 15, then the force imparted by window 11 (represented by the load being displaced by the motor) is monitored. If window 11 presses against any obstructing object then the force (i.e., load) will increase above a threshold. Then window 11 will automatically reverse its direction of motion and allow any obstructing object to be removed. Bounceback region 15 may have a lower limit 16 of about 200 mm from the fully closed position, for example. In some embodiments, bounceback region 15 may also include an upper limit before reaching the closed position, such as about 5 mm.

FIG. 2 shows a powered window system 20 in which a DC motor 21 drives a window mechanism 22. DC Motor 21 generates position pulses as the motor rotor rotates to drive the window mechanism up and down, the position pulses enabling a controller 23 to track the window movement. Controller 23 also receives a current measurement from motor 21 so that a load on motor 21 can be determined and compared to a load corresponding to the force threshold. Controller 23 determines the magnitude of a variable DC voltage to be supplied to motor 21 in order to obtain a desired trajectory of motion (e.g., window speed and starting/stopping positions) during opening or closing of the window. Based on a target voltage determined using feedback control, controller 23 calculates a pulse-width modulated (PWM) frequency and duty cycle which are used to modulate a PW M driver 24. Controller 23 is connected with a human machine interface (HMI) including a switch 25 by which the user can generate a brief control signal to indicate a request for closing of the window.

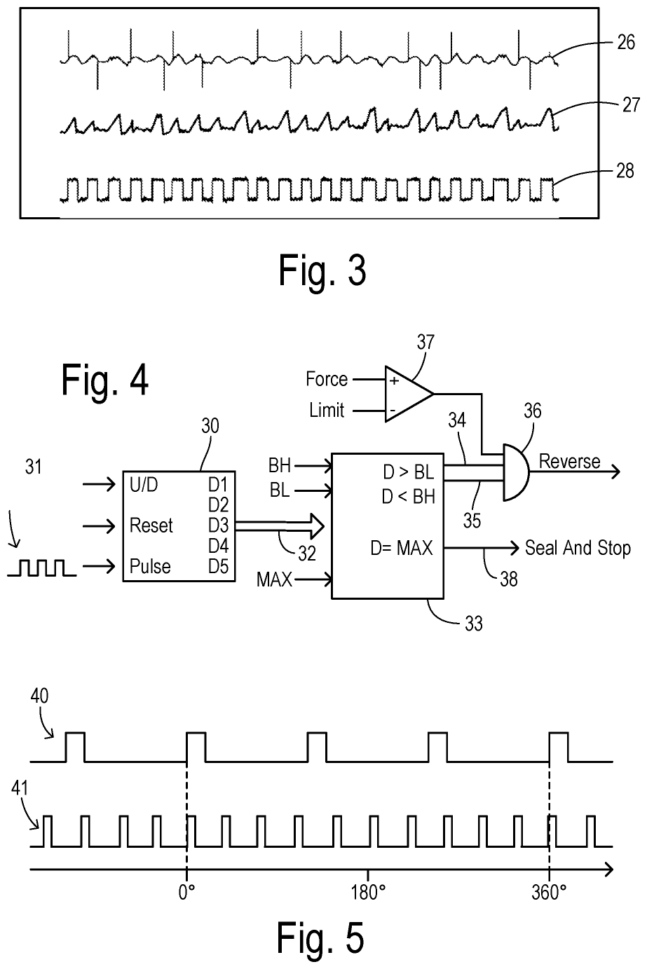

Powered window systems of the type shown in FIG. 2 have utilized either Hall-effect sensing or ripple counting to generate the position pulses for controller 23. In the ripple counting, the same measured current signal utilized by controller 23 for determining load on the motor can serve as a source signal to be analyzed to isolate back EMF ripples. As shown in FIG. 3, generating ripple pulses starts with a current signal 26 flowing through the rotor of the motor in response to the current delivered by PWM driver 24. To isolate a ripple signal, motor current 26 may be bandpass filtered and passed through a pulse amplifier to generate a ripple signal 27. Ripple signal 27 is applied to a comparator which employs an appropriate threshold to generate a square wave signal having a switching frequency equal to the motor ripple fundamental frequency. However, pulse signal 28 is subject to lost pulses resulting from motor transients, noise, and the relatively small magnitude of the signals to be detected.

FIG. 4 shows how a position signal pulse may be used to track window position. Position pulse signal 31 (occurring when predetermined points on the rotor pass a predetermined reference point) is applied to a counter 30 which may count pulses upward during rotor rotation in a window-closing direction and count downward during window opening, for example. A digital count (D) 32 may be input to a comparator 33 which also receives predetermined constants including a bounceback low threshold count (BL) and a bounceback high threshold count (BH). While digital count 32 increases during closing motion of the window, it is compared with low count threshold BL. An output 34 provides a high logic level signal to an input of an AND-gate 36 when count 32 is greater than threshold BL. Count 32 is also compared with high count threshold BH and a high logic level signal is provided via an output 35 to another input of AND-gate 36 when count 32 is less than high count threshold BH. When the logic signals from outputs 34 and 35 are high, then AND-gate 36 generates an output according to the output of a comparator 37. The force (e.g., motor load) is coupled to a noninverting input of comparator 37, and a force limit is coupled to an inverting input. When the force exceeds the limit then a high logic level signal is provided to another input of AND-gate 36. Since all inputs are high, a reverse signal is output by A N D-gate 36 to activate the anti-impingement feature. Comparator 33 may also receive a predetermined constant M A X corresponding to the value of digital count 32 when the window reaches the fully closed position. Comparator 33 compares count 32 with threshold MAX and may generate an output 38 indicating the closed position, thereby instructing the controller to perform an operation which compresses the window against its seals and then stops the automatic motion.

FIG. 5 compares resolution of a Hall-effect position pulse signal 40 with a ripple count position pulse signal 41 which are typical using DC brushed motors of the type employed for power window and other powered closure applications in vehicles. As the motor rotor rotates from a predefined 0° position through one full rotation at 360°, Hall-effect signal 40 provides four pulses. Meanwhile, ripple signal 41 provides 11 pulses, thereby enabling an increase in the accuracy of tracking motor rotation.

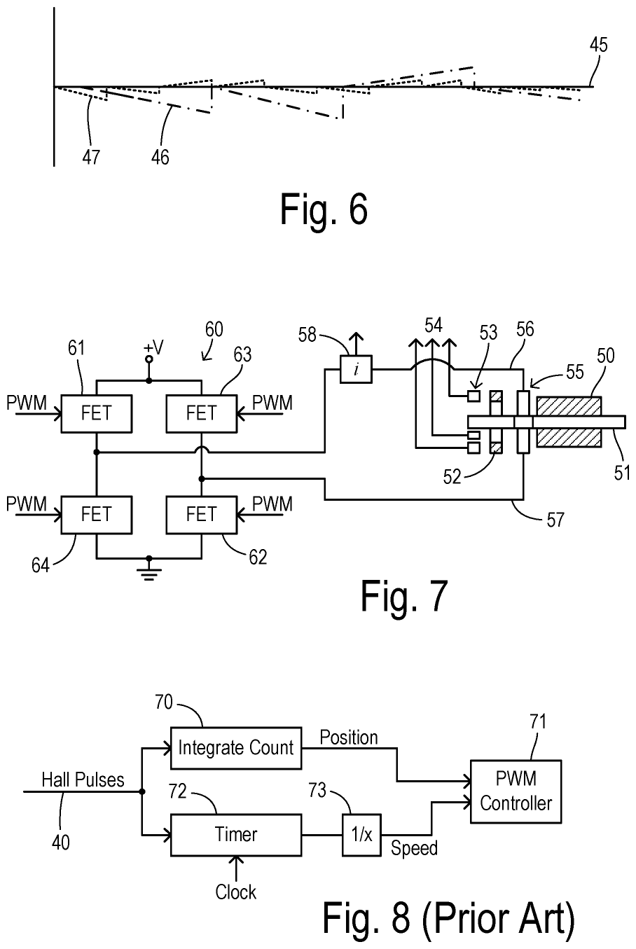

As a result, using the ripple signal 41 provides better tracking of a desired motor speed as shown in FIG. 6. A horizontal line 45 represents a desired speed trajectory. Using a low resolution of Hall-effect signal 40 would result in a motor speed following a path 46. Using higher resolution data from ripple signal 41 provides a speed path 47. Path 46 provides significantly larger deviations from target speed 45 than path 47 based on ripple counting.

FIG. 7 shows portion of portions of a motor drive in greater detail. The DC motor includes a rotor 50 mounted to a shaft 51 that rotates when coils in rotor 50 are energized. A magnetic disk 52 is mounted on shaft 51 for rotating with rotor 50. Hall sensor elements 53 are mounted adjacent disk 52 to provide Hall-effect signals 54 as magnets embedded in disk 52 rotate past elements 53. Signals 54 can be decoded by the controlled to track motor position. The DC motor further includes a commutator/brush mechanism 55 which are connected to receive the DC drive signal at conductors 56 and 57. A current sensor 58 is connected in series with commutator 55 to provide the current signal used for counting and/or motor load determinations.

An H-bridge circuit 60 has field-effect transistors (FETs) 61 and 62 connected to couple a voltage from a DC voltage supply (+V) in one direction through commutator 55, and FETs 63 and 64 are connected to supply the DC voltage with a reverse polarity to commutator 55 (in order to rotate rotor 50 in the other direction). FET transistors 61-64 receive PWM driver signals from the PWM controller.

FIG. 8 illustrates a known technique of using Hall-effect position pulses 40 for determining both motor position and speed. Hall pulses 40 are integrated in a counter 70 to generate the digital count representing cumulative movement of the motor and window. The Hall pulses 40 are also input to a timer 72 which uses a clock to determine a time interval between successive Hall pulses 40. A reciprocal of the measured time period is obtained in an inverter 73 to provide a speed value which is coupled to a PWM controller 71 along with the integrated position count.

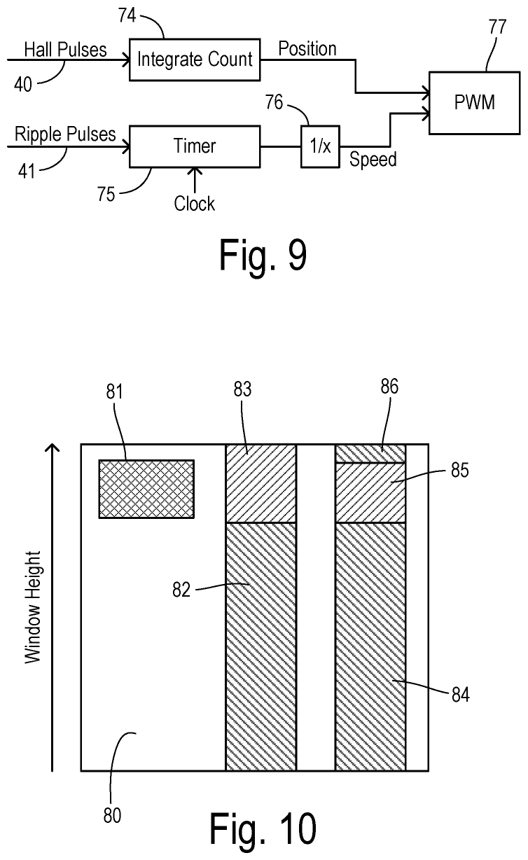

As shown in FIG. 9, some embodiments combine reliable position monitoring made possible by Hall-effect pulse signals together with a higher resolution of ripple position pulses for determining speed and obtaining improved smooth speed profiles during window movement. Thus, a counter 74 integrates the Hall position pulses 40 to provide a position count to PWM controller 77. Simultaneously, ripple pulses 41 are monitored by timer 75 at the higher resolution. Successive time periods may be averaged or individual periods can be output from timer 75 to an inverter 76<which provides a speed signal to PWM controller 77 used in controlling the H-bridge a known manner.

FIG. 10 shows one of the advantages of the present invention. A window opening 80 is shown having a window height range corresponding to a bounceback region 81. During express movement occurring below bounceback region 81, a relatively higher window load may be tolerated, represented by a region 82. Once the window height enters bounceback region 81, then a lower force threshold is utilized in a region 83. In the prior art using only ripple counting to monitor position of the window, a desire to avoid unwanted bounceback may necessitate using the lower force threshold 83 all the way to the point where the window is closed. This may result in a less robust seal of the window (in the closed position) against its gasket or guides in the window opening. In the invention combining the higher reliability position determination of Hall-effect sensors with the higher reliability speed monitoring from ripple counting, the higher force threshold which is utilized in a region 84 below bounceback region 81 can again be used in a final closing region 86 after traversing the low force threshold region 85. Consequently, the window may be more firmly closed and sealed according to the present invention.

1. An apparatus for moving a slidable panel in an opening of a vehicle, the apparatus comprising:
a DC motor comprising a rotor adapted to be mechanically coupled to the slidable panel;
a variable voltage source coupled to the DC motor and configured to supply a selected voltage to rotate the rotor at a respective speed;
a ripple detector configured to detect rotation of the rotor in response to a back electromotive force (EMF) according to first rotation pulses at a first resolution;
a Hall-Effect rotation sensor coupled to the rotor and configured to sense rotation of the rotor according to second rotation pulses at a second resolution, wherein the second resolution is lower than the first resolution; and
a control circuit configured to:
determine a position of the slidable panel by counting the second rotation pulses;
determine a speed of the slidable panel based on a timing of the first rotation pulses; and
move the slidable panel to comply with a predetermined trajectory by adjusting the variable voltage source based on the position of the window panel and the speed of the window panel.

2. The apparatus of claim 1, wherein the variable voltage source is comprises an H-bridge comprising electronically-controlled switching devices coupling a DC supply voltage to the DC motor with a selectable polarity.

3. The apparatus of claim 2, wherein the control circuit is configured to pulse-width modulate the switching devices to deliver an average DC voltage which corresponds to the predetermined trajectory.

4. The apparatus of claim 1, wherein the ripple detector comprises a current sensor configured to detect a current flow through the DC motor, and wherein the control circuit is configured to convert the detected current flow to a ripple signal having pulses corresponding to features of the back EMF.

5. The apparatus of claim 4, wherein the slidable panel is a window panel slidable in a window opening of the vehicle, wherein the control circuit is configured to determine a mechanical force of the DC motor according to the detected current flow, and wherein the control circuit is further configured such that during closing movement of the window panel (1) a current position of the window panel is monitored to detect movement within a bounceback region in which a remaining distance between the current window position and a closed window position of the window panel is between a first distance and a second distance, (2) rotation of the rotor is reversed if the mechanical force becomes greater than a force threshold while the window panel is in the bounceback region, and (3) after the window panel passes through the bounceback region, the movement of the window panel into the closed window position is driven with the mechanical force being greater than the force threshold.

6. A method of moving a slidable window panel in an opening of a vehicle, the method comprising:
receiving a window movement command from a user of the vehicle;
coupling a DC voltage to a DC motor comprising a rotor adapted to be mechanically coupled to the window panel, wherein the rotor rotates at a respective speed proportional to the DC voltage;
generating, via a ripple detector, a ripple signal according to a back electromotive force (EMF) produced by rotation of the rotor, wherein the ripple signal comprises first rotation pulses at a first resolution;
generating, via a Hall-Effect rotation sensor coupled to the rotor, second rotation pulses at a second resolution, wherein the second resolution is lower than the first resolution;
determining a position of the window panel by counting the second rotation pulses;
determining a speed of the window panel by a timing of the first rotation pulses; and
adjusting the DC voltage based on the position of the window panel and the speed of the window panel to follow a predetermined trajectory.

7. The method of claim 6, wherein the DC voltage is generated by an H-bridge comprising electronically-controlled switching devices so that the DC voltage has a selectable polarity.

8. The method of claim 7, wherein adjusting the DC voltage comprises pulse-width modulating the switching devices to deliver an average DC voltage which corresponds to the predetermined trajectory.

9. The method of claim 6, wherein generating the ripple signal comprises detecting a current flow through the DC motor and converting the detected current flow to the first rotation pulses based on features of the back EMF.

10. The method of claim 9, further comprising:
determining a mechanical force of the DC motor according to the detected current flow; and
during closing movement of the window panel:
determining whether a current position of the window panel is within a bounceback region in which a remaining distance between the current window position and a closed window position of the window panel is between a first pinching distance and a second pinching distance;
reversing rotation of the rotor if the mechanical force becomes greater than a force threshold while in the bounceback region; and
driving the movement of the window panel into the closed window position with the mechanical force being greater than the force threshold after the window panel passes through the bounceback region.

11. The method of claim 6, wherein receiving the window movement command comprises receiving the window movement command via a human machine interface (HMI).

12. The method of claim 6, wherein adjusting the DC voltage comprises adjusting the DC voltage via a pulse width modulation (PWM) driver.

13. The method of claim 6, wherein the Hall-Effect rotation sensor comprises a plurality of Hall sensor elements.

14. The method of claim 6, wherein the DC motor further comprises:
a shaft upon which the rotor is mounted; and
a magnetic disk mounted on the shaft.

15. The method of claim 6, wherein the Hall-Effect rotation sensor is mounted adjacent to the magnetic disk.

16. The apparatus of claim 1, further comprising a human machine interface (HMI) coupled to the control circuit and configured to generate a control signal indicative of a request to close the slidable panel.

17. The apparatus of claim 1, further comprising a pulse width modulation (PWM) driver coupled to the DC motor and the control circuit.

18. The apparatus of claim 1, wherein the Hall-Effect rotation sensor comprises a plurality of Hall sensor elements.

19. The apparatus of claim 1, wherein the DC motor further comprises:
a shaft upon which the rotor is mounted; and
a magnetic disk mounted on the shaft.

20. The apparatus of claim 1, wherein the Hall-Effect rotation sensor is mounted adjacent to the magnetic disk.
